(19) United States
(12) Patent Application Publication
(10) Pub. No.: US 2026/0080039 A1
(43) Pub. Date: Mar. 19, 2026

(54) CUSTOMIZED IDENTITY AND ACCESS MANAGEMENT TOKEN GENERATION

(71) Applicant: OKTA, INC., SAN FRANCISCO, CA (US)

(72) Inventors: David LOZANO LLANOS, Valladolid (ES); Charles Henry Fitzgerald REA, Bristol (GB)

(21) Appl. No.: 18/886,485

(22) Filed: Sep. 16, 2024

(51) Int. Cl. G06F 21/31

(52) U.S. Cl. CPC G06F 21/31

(57) ABSTRACT

To generate custom identity and access management (IAM) tokens, an IAM service may receive a set of instructions from an organization to modify a set of parameters of a respective IAM token to enable customized access to one or more services associated with the organization. Further, the IAM service may receive a request for an IAM token from an application associated with the organization based on the IAM service receiving the set of instructions. In response to the request, the IAM service may generate the IAM token for the application and may execute the set of instructions received from the organization to generate a modified IAM token from the initial IAM token. The IAM service may then transmit the modified IAM token to the application based on executing the set of instructions to generate and obtain the modified IAM token.

### FIELD OF TECHNOLOGY

The present disclosure relates generally to identity management, and more specifically to customized identity and access management (IAM) token generation.

### BACKGROUND

An identity management system (e.g., an identity and access management (IAM) system) may be employed to manage and store various forms of user data, including usernames, passwords, email addresses, permissions, roles, group memberships, etc. The identity management system may provide authentication services for applications, devices, users, and the like. The identity management system may enable organizations to manage and control access to resources, for example, by serving as a central repository that integrates with various identity sources. The identity management system may provide an interface that enables users to access a multitude of applications with a single set of credentials.

In some examples, customers of an identity management system or IAM system may have relatively complex integrations for IAM tokens (e.g., tokens used for authentication and authorization purposes). Moreover, while an IAM system may generate IAM tokens and provide customers with relatively large quantities of customization options for the IAM tokens, customers may be unable to customize one or more features of the IAM tokens to ensure the security of the IAM tokens and backwards compatibility due to future updates to the IAM system. Thus, in some cases, customers may implement a proxy service to receive IAM tokens from the IAM service and modify the IAM tokens to be compatible with services associated with the customer. However, implementing such proxy service may increase the complexity of using the IAM system for the user and may result in latency when requesting IAM tokens or transmitting requests to the IAM system.

### SUMMARY

A method for identity and access management (IAM) token generation by an apparatus is described. The method may include receiving, from an organization, a set of instructions to modify a respective IAM token, where the set of instructions are for modifying a set of parameters of the respective IAM token to enable customized access to one or more services associated with the organization, receiving, from the organization via an application, a request for an IAM token based on receiving the set of instructions, generating, in response to the request, the IAM token for the user, executing the set of instructions received from the organization to generate a modified IAM token using the IAM token, and transmitting, to the application, the modified IAM token based on executing the set of instructions to obtain the modified IAM token.

An apparatus for IAM token generation is described. The apparatus may include one or more memories storing processor executable code, and one or more processors coupled with the one or more memories. The one or more processors may individually or collectively be operable to execute the code to cause the apparatus to receive, from an organization, a set of instructions to modify a respective IAM token, where the set of instructions are for modifying a set of parameters of the respective IAM token to enable customized access to one or more services associated with the organization, receive, from the organization via an application, a request for an IAM token based on receiving the set of instructions, generate, in response to the request, the IAM token for the user, execute the set of instructions received from the organization to generate a modified IAM token using the IAM token, and transmit, to the application, the modified IAM token based on executing the set of instructions to obtain the modified IAM token.

Another apparatus for IAM token generation is described. The apparatus may include means for receiving, from an organization, a set of instructions to modify a respective IAM token, where the set of instructions are for modifying a set of parameters of the respective IAM token to enable customized access to one or more services associated with the organization, means for receiving, from the organization via an application, a request for an IAM token based on receiving the set of instructions, means for generating, in response to the request, the IAM token for the user, means for executing the set of instructions received from the organization to generate a modified IAM token using the IAM token, and means for transmitting, to the application, the modified IAM token based on executing the set of instructions to obtain the modified IAM token.

A non-transitory computer-readable medium storing code for identity and access management (IAM) token generation is described. The code may include instructions executable by one or more processors to receive, from an organization, a set of instructions to modify a respective IAM token, where the set of instructions are for modifying a set of parameters of the respective IAM token to enable customized access to one or more services associated with the organization, receive, from the organization via an application, a request for an IAM token based on receiving the set of instructions, generate, in response to the request, the IAM token for the user, execute the set of instructions received from the organization to generate a modified IAM token using the IAM token, and transmit, to the application, the modified IAM token based on executing the set of instructions to obtain the modified IAM token.

Some examples of the method, apparatus, and non-transitory computer-readable medium described herein may further include operations, features, means, or instructions for receiving, from the organization, a second set of instructions to modify a first IAM token that may be used to access the one or more services associated with the organization, where the second set of instructions indicate instructions for modifying a set of parameters of the first IAM token to enable access to an identity provider, receiving, from the organization via the application and based on receiving the second set of instructions, a request for information from the identity provider, the request including the first IAM token, executing, in response to receiving the request, the second set of instructions to generate a second IAM token to enable customized access to the identity provider, querying the identity provider using the second IAM token generated by executing the second set of instructions to obtain the information associated with the request, and transmitting, to the application, the information associated with the request based on querying the identity provider.

In some examples of the method, apparatus, and non-transitory computer-readable medium described herein, the second set of instructions may be executed when the request may be received or subsequent to receiving the request.

In some examples of the method, apparatus, and non-transitory computer-readable medium described herein, executing the set of instructions may include operations, features, means, or instructions for including in the modified IAM token that may be generated via the set of instructions an indication that the modified IAM token was generated based on executing the set of instructions, including a signature from an identity provider in the modified IAM token, or both.

Some examples of the method, apparatus, and non-transitory computer-readable medium described herein may further include operations, features, means, or instructions for receiving, from the application, a request including the modified IAM token that includes the indication and transmitting, to the application, a denial of the request based on the modified IAM token including the indication.

In some examples of the method, apparatus, and non-transitory computer-readable medium described herein, executing the set of instructions may include operations, features, means, or instructions for modifying one or more parameters of the IAM token to generate the modified IAM token.

Some examples of the method, apparatus, and non-transitory computer-readable medium described herein may further include operations, features, means, or instructions for modifying the one or more parameters of the IAM token includes adding additional parameters, removing parameters, updating a value of one or more respective parameters, or any combination thereof.

In some examples of the method, apparatus, and non-transitory computer-readable medium described herein, receiving the set of instructions may include operations, features, means, or instructions for receiving, from the organization, a unit of executable code, a computer program, or a combination thereof that include the set of instructions.

### BRIEF DESCRIPTION OF THE DRAWINGS

FIG. 1 illustrates an example of a computing system that supports customized identity and access management (IAM) token generation in accordance with aspects of the present disclosure.

FIG. 2 shows an example of a token generation system that supports customized IAM token generation in accordance with aspects of the present disclosure.

FIG. 3 shows an example of a process flow that supports customized IAM token generation in accordance with aspects of the present disclosure.

FIG. 4 shows a block diagram of an apparatus that supports customized IAM token generation in accordance with aspects of the present disclosure.

FIG. 5 shows a block diagram of a token generation module that supports customized IAM token generation in accordance with aspects of the present disclosure.

FIG. 6 shows a diagram of a system including a device that supports customized IAM token generation in accordance with aspects of the present disclosure.

FIG. 7 shows a flowchart illustrating methods that support customized IAM token generation in accordance with aspects of the present disclosure.

### DETAILED DESCRIPTION

In some identity management systems or identity and access management (IAM) systems, organizations (e.g., customers, users, tenants, and the like) may customize different protocols by customizing IAM tokens. In some examples, an IAM token may be a token used to provide authorization and authentication on behalf of an authorized entity (e.g., a user of an organization). By enabling organizations to customize IAM tokens, customers may be capable of using the IAM tokens outside of the IAM system. For example, by customizing an IAM token, an organization may use the IAM token for authentication and authorization within services or applications associated with the organization. However, to ensure a relatively high level of security and backwards capability, the IAM system may limit the amount of customization of IAM tokens that an organization may perform. Further, in some cases relatively large organizations may have relatively complex integrations and special requirements such that the organization may be unable to customize an IAM token due to the customization limitations set by the IAM service. Thus, in some examples, customers may create proxy services to alter or modify IAM tokens. However, implementation of such proxy services may increase the cost and complexity for an organization using the IAM service provided by the IAM system.

To reduce the cost and complexity of using an IAM service provided by an IAM system, the IAM system may generate customized IAM tokens for customers rather than having customers implement a proxy service to generate the customized IAM tokens. To generate the customized IAM tokens, the IAM service may receive a set of instructions from an organization that indicate instructions to modify a respective IAM token. For example, the set of instructions may be for modifying a set of parameters of the respective IAM token to enable customized access to one or more services associated with the organization. Further, the IAM service may receive a request from the organization, via an application for an IAM token based, on the IAM service receiving the set of instructions. The IAM service may then execute the set of instructions received from the organization to generate a modified IAM token using the initial IAM token, and may transmit the modified IAM token to the application that requested the IAM token based on executing the set of instructions and obtaining the modified IAM token.

In some cases, the IAM service may receive a second set of instructions to modify a first IAM token that is used to access the one or more services associated with the organization. The second set of instructions may indicate instructions for modifying a set of parameters of a first IAM token to enable access to an identity provider. Based on receiving the second set of instructions, the IAM service may receive a request for information from the identity provider form the organization via an application, where the request includes the first IAM token. The IAM service may then execute the second set of instructions to generate a second IAM token to enable access to the identity provider. Moreover, based on executing the second set of instructions, the IAM service may use the second IAM token to query the identity provider to obtain the information associated with the request from the application. The IAM service may then transmit the information associated with the request to the application based on querying the identity provider. In some cases, when executing the set of instructions, the IAM service may include an indication that the modified IAM token was generated by executing the set of instructions. Additionally, or alternatively, the IAM service may include a signature from the identity provider in the modified IAM token to further indicate that the respective IAM token was modified by the identity provider.

By obtaining the set of instructions from an organization, the IAM service may generate customized IAM tokens for the organization to prevent the organization from having to implement a proxy service. Therefore, the techniques of the present disclosure may reduce the complexity of using the IAM service for organizations by generating the modified IAM tokens in accordance with the set of instructions provide by the organization within the IAM service directly. Moreover, the IAM service may receive tokens from the customer and modifying the tokens to be capable of querying an identity provider associated with the IAM service.

Aspects of the disclosure are initially described in the context of a computing system. Additional aspects of the disclosure are described with reference to a token generation system and a process flow. Aspects of the disclosure are further illustrated by and described with reference to apparatus diagrams, system diagrams, and flowcharts that relate to customized IAM token generation.

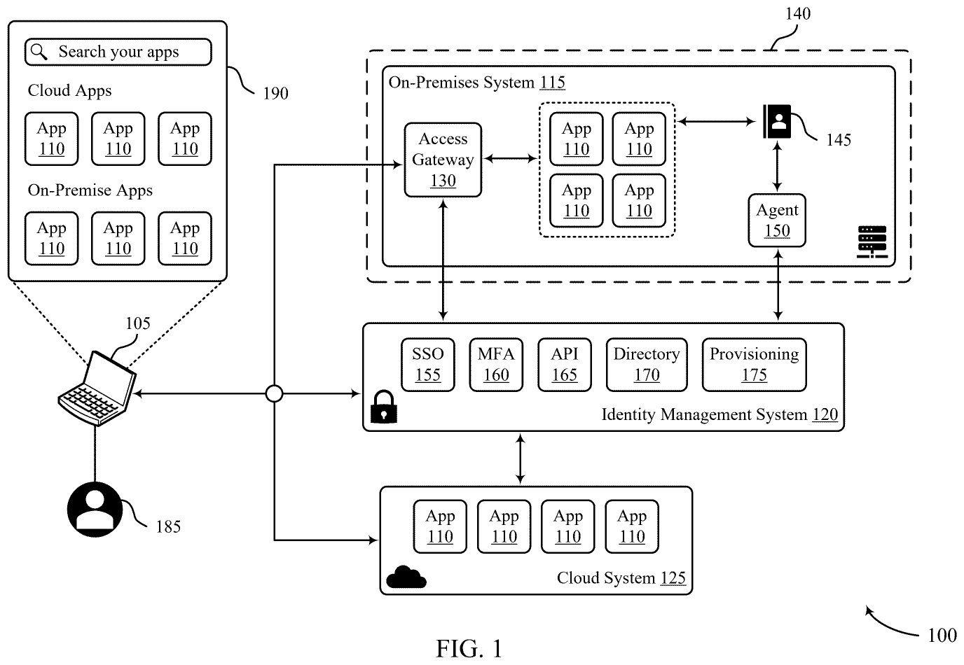

FIG. 1 illustrates an example of a computing system 100 that supports customized IAM token generation in accordance with various aspects of the present disclosure. The computing system 100 includes a computing device 105 (such as a desktop, laptop, smartphone, tablet, or the like), an on-premises system 115, an identity management system 120, and a cloud system 125, which may communicate with each other via a network, such as a wired network (e.g., the Internet), a wireless network (e.g., a cellular network, a wireless local area network (WLAN)), or both. In some cases, the network may be implemented as a public network, a private network, a secured network, an unsecured network, or any combination thereof. The network may include various communication links, hubs, bridges, routers, switches, ports, or other physical and/or logical network components, which may be distributed across the computing system 100.

The on-premises system 115 (also referred to as an on-premises infrastructure or environment) may be an example of a computing system in which a client organization owns, operates, and maintains its own physical hardware and/or software resources within its own data center(s) and facilities, instead of using cloud-based (e.g., off-site) resources. Thus, in the on-premises system 115, hardware, servers, networking equipment, and other infrastructure components may be physically located within the “premises” of the client organization, which may be protected by a firewall 140 (e.g., a network security device or software application that is configured to monitor, filter, and control incoming/outgoing network traffic). In some examples, users may remotely access or otherwise utilize compute resources of the on-premises system 115, for example, via a virtual private network (VPN).

In contrast, the cloud system 125 (also referred to as a cloud-based infrastructure or environment) may be an example of a system of compute resources (such as servers, databases, virtual machines, containers, and the like) that are hosted and managed by a third-party cloud service provider using third-party data center(s), which can be physically co-located or distributed across multiple geographic regions. The cloud system 125 may offer high scalability and a wide range of managed services, including (but not limited to) database management, analytics, machine learning (ML), artificial intelligence (AI), etc. Examples of cloud systems 125 include (AMAZON WEB SERVICES) AWS®, MICROSOFT AZURE®, GOOGLE CLOUD PLATFORM®, ALIBABA CLOUD®, ORACLE® CLOUD INFRASTRUCTURE (OCI), and the like.

The identity management system 120 may support one or more services, such as a single sign-on (SSO) service 155, a multi-factor authentication (MFA) service 160, an application programming interface (API) service 165, a directory management service 170, or a provisioning service 175 for various on-premises applications 110 (e.g., applications 110 running on compute resources of the on-premises system 115) and/or cloud applications 110 (e.g., applications 110 running on compute resources of the cloud system 125), among other examples of services. The SSO service 155, the MFA service 160, the API service 165, the directory management service 170, and/or the provisioning service 175 may be individually or collectively provided (e.g., hosted) by one or more physical machines, virtual machines, physical servers, virtual (e.g., cloud) servers, data centers, or other compute resources managed by or otherwise accessible to the identity management system 120.

A user 185 may interact with the computing device 105 to communicate with one or more of the on-premises system 115, the identity management system 120, or the cloud system 125. For example, the user 185 may access one or more applications 110 by interacting with an interface 190 of the computing device 105. In some implementations, the user 185 may be prompted to provide some form of identification (such as a password, personal identification number (PIN), biometric information, or the like) before the interface 190 is presented to the user 185. In some implementations, the user 185 may be a developer, customer, employee, vendor, partner, or contractor of a client organization (such as a group, business, enterprise, non-profit, or startup that uses one or more services of the identity management system 120). The applications 110 may include one or more on-premises applications 110 (hosted by the on-premises system 115), mobile applications 110 (configured for mobile devices), and/or one or more cloud applications 110 (hosted by the cloud system 125).

The SSO service 155 of the identity management system 120 may allow the user 185 to access multiple applications 110 with one or more credentials. Once authenticated, the user 185 may access one or more of the applications 110 (for example, via the interface 190 of the computing device 105). That is, based on the identity management system 120 authenticating the identity of the user 185, the user 185 may obtain access to multiple applications 110, for example, without having to re-enter the credentials (or enter other credentials). The SSO service 155 may leverage one or more authentication protocols, such as Security Assertion Markup Language (SAML) or OpenID Connect (OIDC), among other examples of authentication protocols. In some examples, the user 185 may attempt to access an application 110 via a browser. In such examples, the browser may be redirected to the SSO service 155 of the identity management system 120, which may serve as the identity provider (IdP). For example, in some implementations, the browser (e.g., the user's request communicated via the browser) may be redirected by an access gateway 130 (e.g., a reverse proxy-based virtual application configured to secure web applications 110 that may not natively support SAML or OIDC).

In some examples, the access gateway 130 may support integrations with legacy applications 110 using hypertext transfer protocol (HTTP) headers and Kerberos tokens, which may offer universal resource locator (URL)-based authorization, among other functionalities. In some examples, such as in response to the user's request, the IdP may prompt the user 185 for one or more credentials (such as a password, PIN, biometric information, or the like) and the user 185 may provide the requested authentication credentials to the IdP. In some implementations, the IdP may leverage the MFA service 160 for added security. The IdP may verify the user's identity by comparing the credentials provided by the user 185 to credentials associated with the user's account. For example, one or more credentials associated with the user's account may be registered with the IdP (e.g., previously registered, or otherwise authorized for authentication of the user's identity via the IdP). The IdP may generate a security token (such as a SAML token or Oath 2.0 token) containing information associated with the identity and/or authentication status of the user 185 based on successful authentication of the user's identity.

The IdP may send the security token to the computing device 105 (e.g., the browser or application 110 running on the computing device 105). In some examples, the application 110 may be associated with a service provider (SP), which may host or manage the application 110. In such examples, the computing device 105 may forward the token to the SP. Accordingly, the SP may verify the authenticity of the token and determine whether the user 185 is authorized to access the requested applications 110. In some examples, such as examples in which the SP determines that the user 185 is authorized to access the requested application, the SP may grant the user 185 access to the requested applications 110, for example, without prompting the user 185 to enter credentials (e.g., without prompting the user to log-in). The SSO service 155 may promote improved user experience (e.g., by limiting the number of credentials the user 185 has to remember/enter), enhanced security (e.g., by leveraging secure authentication protocols and centralized security policies), and reduced credential fatigue, among other benefits.

The MFA service 160 of the identity management system 120 may enhance the security of the computing system 100 by prompting the user 185 to provide multiple authentication factors before granting the user 185 access to applications 110. These authentication factors may include one or more knowledge factors (e.g., something the user 185 knows, such as a password), one or more possession factors (e.g., something the user 185 is in possession of, such as a mobile app-generated code or a hardware token), or one or more inherence factors (e.g., something inherent to the user 185, such as a fingerprint or other biometric information). In some implementations, the MFA service 160 may be used in conjunction with the SSO service 155. For example, the user 185 may provide the requested login credentials to the identity management system 120 in accordance with an SSO flow and, in response, the identity management system 120 may prompt the user 185 to provide a second factor, such as a possession factor (e.g., a one-time passcode (OTP), a hardware token, a text message code, an email link/code). The user 185 may obtain access (e.g., be granted access by the identity management system 120) to the requested applications 110 based on successful verification of both the first authentication factor and the second authentication factor.

The API service 165 of the identity management system 120 can secure APIs by managing access tokens and API keys for various client organizations, which may enable (e.g., only enable) authorized applications (e.g., one or more of the applications 110) and authorized users (e.g., the user 185) to interact with a client organization's APIs. The API service 165 may enable client organizations to implement customizable login experiences that are consistent with their architecture, brand, and security configuration. The API service 165 may enable administrators to control user API access (e.g., whether the user 185 and/or one or more other users have access to one or more particular APIs). In some examples, the API service 165 may enable administrators to control API access for users via authorization policies, such as standards-based authorization policies that leverage OAuth 2.0. The API service 165 may additionally, or alternatively, implement role-based access control (RBAC) for applications 110. In some implementations, the API service 165 can be used to configure user lifecycle policies that automate API onboarding and off-boarding processes.

The directory management service 170 may enable the identity management system 120 to integrate with various identity sources of client organizations. In some implementations, the directory management service 170 may communicate with a directory service 145 of the on-premises system 115 via a software agent 150 installed on one or more computers, servers, and/or devices of the on-premises system 115. Additionally, or alternatively, the directory management service 170 may communicate with one or more other directory services, such as one or more cloud-based directory services. As described herein, a software agent 150 generally refers to a software program or component that operates on a system or device (such as a device of the on-premises system 115) to perform operations or collect data on behalf of another software application or system (such as the identity management system 120).

The provisioning service 175 of the identity management system 120 may support user provisioning and deprovisioning. For example, in response to an employee joining a client organization, the identity management system 120 may automatically create accounts for the employee and provide the employee with access to one or more resources via the accounts. Similarly, in response to the employee (or some other employee) leaving the client organization, the identity management system 120 may autonomously deprovision the employee's accounts and revoke the employee's access to the one or more resources (e.g., with little to no intervention from the client organization). The provisioning service 175 may maintain audit logs and records of user deprovisioning events, which may help the client organization demonstrate compliance and track user lifecycle changes. In some implementations, the provisioning service 175 may enable administrators to map user attributes and roles (e.g., permissions, privileges) between the identity management system 120 and connected applications 110, ensuring that user profiles are consistent across the identity management system 120, the on-premises system 115, and the cloud system 125.

In some examples, to reduce the cost and complexity of an organization using an IAM service provided by an IAM system that is associated with the identity management system 120, the IAM system may generate customized IAM tokens for customers rather than having customers (e.g., users 185) implement proxy services to generate the customized IAM tokens. To generate the customized IAM tokens, the IAM service may receive a set of instructions from an organization (e.g., a user 185) that indicate instructions to modify a respective IAM token. For example, the set of instructions may be for modifying a set of parameters of the respective IAM token to enable customized access to one or more services associated with the organization. Further, the IAM service may receive a request from the organization via an application for an IAM token based on the IAM service receiving the set of instructions. The IAM service may then execute the set of instructions received from the organization to generate a modified IAM token using the initial IAM token and may transmit the modified IAM token to the application that requested the IAM token based on executing the set of instructions and obtaining the modified IAM token. Thus, the techniques of the present disclosure may describe enabling an IAM service of the identity management system 120 to generate customized IAM tokens for organizations to provide for a relatively more efficient IAM service for organizations.

Although not depicted in the example of FIG. 1, a person skilled in the art would appreciate that the identity management system 120 may support or otherwise provide access to any number of additional or alternative services, applications 110, platforms, providers, or the like. In other words, the functionality of the identity management system 120 is not limited to the exemplary components and services mentioned in the preceding description of the computing system 100. The description herein is provided to enable a person skilled in the art to make or use the present disclosure. Various modifications to the present disclosure will be readily apparent to those skilled in the art, and the generic principles defined herein may be applied to other variations without departing from the scope of the present disclosure. Accordingly, the present disclosure is not limited to the examples and designs described herein, but is to be accorded the broadest scope consistent with the principles and novel features disclosed herein.

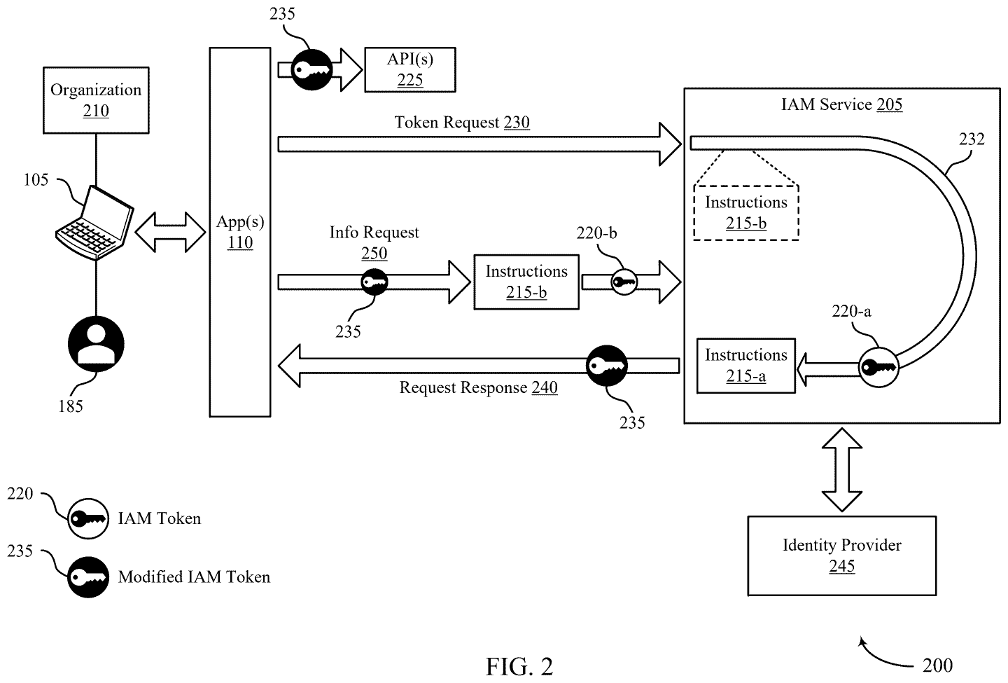

FIG. 2 shows an example of a token generation system 200 that supports customized IAM token generation in accordance with aspects of the present disclosure. In some examples, the token generation system 200 may implement or be implemented by the system 100. In some cases, the token generation system 200 may be performed by devices or services described herein with reference to FIG. 1. For example, the token generation system 200 may utilize an IAM service 205 for users 185 of an organization 210 to access one or more applications associated with the organization 210 via a computing device 105, which may be examples of services or devices as described with reference to FIG. 1.

In some examples, to prevent implementing proxy services, organizations 210 may transmit a set of instructions 215 (e.g., a set of instructions 215-a, a set of instructions 215-b, or both) to an IAM service 205 such that the IAM service 205 can modify tokens (e.g., tokens to provide authentication and authorization for users 185) for use by applications 110 associated with the organization 210. For example, an organization 210 may provide the IAM service 205 with the set of instructions 215-a to modify a respective IAM token 220. Moreover, the set of instructions 215-a may instruct the IAM service 205 to modify a set of parameters of a respective IAM token 220 to enable customized access to one or more services (e.g., APIs 225) associated with the organization 210.

In some cases, subsequent to receiving the set of instructions 215-a from the organization 210, the IAM service 205 may receive a token request message 230 from an application 110 associated with the organization 210. The token request message 230 may request the IAM service 205 for a token. In response to receiving the token request message 230, the IAM service 205 may generate an IAM token 220-a during an IAM pipeline 232. For example, during the IAM pipeline 232, the IAM service 205 may use information within the token request message 230 to generate the IAM token 220-a for the application 110 to act on behalf of a respective user 185 indicated within the token request message 230. Based on the generation of the IAM token 220-a during the IAM pipeline 232, the IAM service 205 may then execute the set of instructions 215-a received from the organization 210 to generate a modified IAM token 235 using the IAM token 220-a. Thus, based on executing the set of instructions 215-a to generate and obtain the modified IAM token 235, the IAM service 205 may transmit a request response message 240 that includes the modified IAM token 235 to the application 110 that transmitted the token request message 230.

In some examples, the modified IAM token 235 may provide a respective application 110 associated with the organization 210 customized access to a set of APIs 225 associated with the organization 210. Moreover, an application 110 may use the modified IAM token 235 to transmit one or more calls to various APIs 225 associated with organization 210 on the behalf of a respective user 185. In some cases, the modified IAM token 235 may include authentication and authorization information for a respective user 185 such that a respective application can use the modified IAM token 235 to act on the behalf of the respective user 185. Further, due to the IAM service 205 executing the set of instructions 215-a, the modified IAM token 235 may be customized for being used in calls to the APIs 225 to access information from services associated with the organization 210. For example, an application 110 may call to an API 225 that includes the modified IAM token 235 to request information from a database associated with the organization 210 on the behalf of a user 185 of a computing device 105. Thus, based on the call to the API 225 including the modified IAM token 235, the API 225 may be capable of returning information from the database that the user 185 has permissions to access.

In some cases, when executing the set of instructions 215-a to generate the modified IAM token 235, the IAM service 205 may include an indication in the modified IAM token 235 that indicates that the modified IAM token 235 was generated by the IAM service 205 by executing the IAM service 205. Further, the IAM service 205 may include a signature from an identity provider 245 that is associated with the IAM service 205 within the modified IAM token 235. In some cases, the identity provider 245 may be associated with an authentication server, an authorization server, or both such that the identity provider 245 can provide information for authenticating and authorizing access to respective users 185. Further, by including the modification indication, the signature, or both in the modified IAM token 235, the IAM service 205 may determine whether a token received by the IAM service 205 was modified by the IAM service 205. For example, when the IAM service 205 queries the identity provider 245 the IAM service 205 may have to ensure that a token used within the query is non-modified as using the modified IAM token 235 can result in information being received from the identity provider 245 that an application 110 or a user 185 is unauthorized to access.

Therefore, to ensure that the tokens used for queries to the identity provider 245 are unmodified, the IAM service 205 may receive a second set of instructions (e.g., the set of instructions 215-b) from the organization 210 to modify a first IAM token (e.g., a modified IAM token 235) that is used to access the one or more services associated with the organization 210. Further, the set of instructions 215-b may indicate instructions for modifying a set of parameters of the first IAM token to enable access to the identity provider 245. Moreover, in some cases, the IAM service 205 may receive a request 250 for information from the identity provider 245 that includes the first IAM token (e.g., the modified IAM token 235 or a token generated by an application 110 or service associated with the organization). For example, an application 110 may transmit a request 250 for user information from the identity provider 245 on the behalf of a user 185 and the request 250 may include a modified IAM token 235. Based on receiving the request 250, the IAM service 205 may then execute the second set of instructions to modify the parameters of the modified IAM token 235 to generate an IAM token 220-b that can access the identity provider 245. The IAM service 205 may then use the IAM token 220-b to query the identity provider 245 for the information requested by the request 250. Moreover, without executing the set of instructions 215-b, in some cases the IAM service 205 may deny a request 250. For example, if the IAM service 205 receives a request 250 that includes an IAM token with an indication that the token was modified by the IAM service 205, the IAM service 205 may transmit a denial of the request 250 to the application 110 based on the token including the modification indication.

In some cases, the IAM service 205 may execute the set of instructions 215-b before the IAM pipeline 232 or during the IAM pipeline 232. For example, in some cases, the IAM service 205 may modify the parameters of the modified IAM token 235 prior to generating a query to the identity provider 245 with the IAM token 220-b. In some other cases, during the IAM pipeline 232 of generating a query to the identity provider 245, the IAM service 205 may execute the second set of instructions (e.g., the set of instructions 215-b) to generate the IAM token 220-b for querying the identity provider 245. Further, based on querying the identity provider 245 for the information associated with the request 250 using the IAM token 220-b, the IAM service 205 may transmit the request response message 240 that indicates the information requested by the application via the request 250. For example, the request response message 240 may indicate the user information of a respective user 185 from the identity provider 245 such that the application 110 can act on the behalf of the respective user 185.

In some examples, the IAM service 205 may receive the set of instructions 215 (e.g., the set of instructions 215-a or the set of instructions 215-a) from the organization 210 via a unit of executable code, a computer program, from a database, or any combination thereof. For example, the organization 210 may transmit a computer program or a unit of executable code that include the set of instructions 215 to modify a respective IAM token to the IAM service 205. Additionally, or alternatively, the IAM service 205 may receive the set of instructions 215 from a database that has the set of instructions 215 stored in the database that is associated with the organization 210 or a set of organizations 210. Further, the set of instructions 215 may include instructions to modify one or more parameters of a respective IAM token (e.g., a respective IAM token 220 or a modified IAM token 235). For example, the modifications to the one or more parameters may include adding additional parameters, removing parameters, updating a value of one or more respective parameters, or any combination thereof.

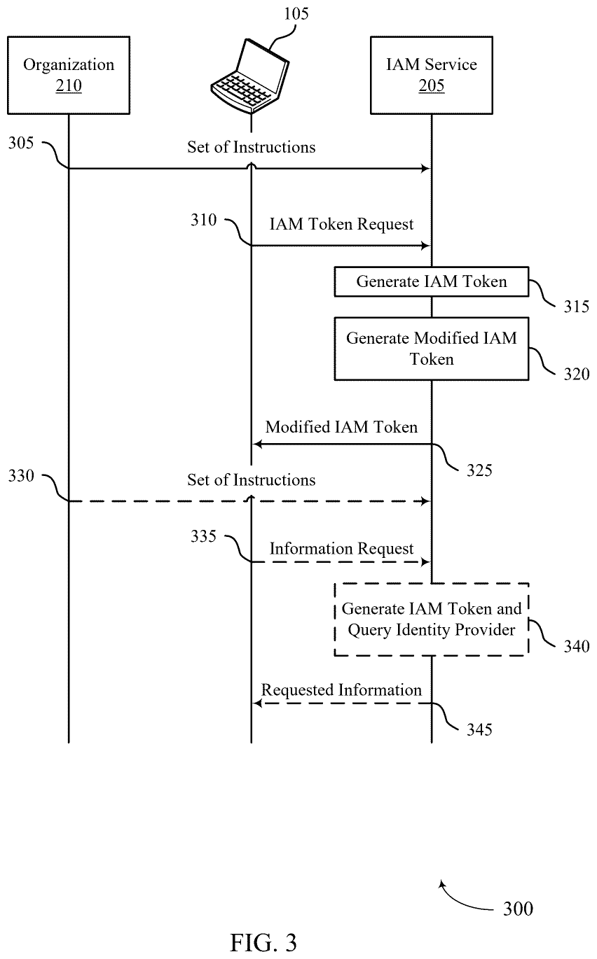

Thus, by modifying the parameters of a respective token (e.g., a respective IAM token 220 or a modified IAM token 235) in accordance with the techniques of the present disclosure, the IAM service 205 may be capable of ensuring a relatively high level of security by generating all the tokens within the IAM service 205 and reducing the complexity for the organization 210 to use the IAM service 205. Moreover, by having the modified IAM token 235 generated via the IAM service 205 rather than a proxy service, organizations 210 may experience a more secure token generation process and have a reduction in latency when requesting tokens to be generated. Further descriptions of the techniques of the present disclosure may be described elsewhere herein, such as with reference to FIG. 3.

FIG. 3 shows an example of a process flow 300 that supports customized IAM token generation in accordance with aspects of the present disclosure. In some examples, the process flow 300 may implement or be implemented by the system 100, token generation system 200, or both. For example, the process flow 300 may include a computing device 105, a IAM service 205, and an organization 210, which may be examples of devices described herein with reference to FIG. 1.

In the following description of the process flow 300, the operations between the computing device 105, the IAM service 205, and the organization 210 may be performed in different orders or at different times. Some operations may also be left out of the process flow 300, or other operations may be added. Although the computing device 105, the IAM service 205, and the organization 210 are shown performing the operations of the process flow 300, some aspects of some operations may also be performed by one or more other wireless devices.

At 305, the IAM service 205 may receive, from the organization 210, a set of instructions to modify a respective IAM token where the set of instructions are for modifying a set of parameters of the respective IAM token to enable customized access to one or more services associated with the organization 210. Further, receiving the set of instructions may include, the IAM service 205 receiving, from the organization 210, a unit of executable code, a computer program, or a combination thereof that includes the set of instructions.

At 310, the IAM service 205 may receive, from the organization 210 via an application, a request for an IAM token based on receiving the set of instructions. At 315, the IAM service 205 may generate, in response to the request, the IAM token for the user. At 320, the IAM service 205 may execute the set of instructions received from the organization 210 to generate a modified IAM token using the IAM token. In some examples, when generating the modified IAM token, the IAM service 205 may include in the modified IAM token an indication that the modified token was generated based on executing the set of instructions. Additionally, or alternatively, the IAM service 205 may include a signature from an identity provider in the modified token. In some other examples, executing the set of instructions may include the IAM service 205 modifying one or more parameters of the IAM token to generate the modified IAM token. For example, modifying the one or more IAM token may include the IAM service 205 adding additional parameters, removing parameters, updating a value of one or more respective parameters, or any combination thereof.

At 325, the IAM service 205 may transmit, to an application on the computing device 105, the modified IAM token based on executing the set of instructions to obtain the modified IAM token. In some cases, the IAM service 205 may subsequently receive a request from the application that includes the modified IAM token that includes an indication that the modified IAM token was generated based on executing the instructions. In response, the IAM service 205 may transmit, to the application, a denial of the request based on the modified IAM token including the indication.

In some cases, at 330, the IAM service 205 may receive, from the organization 210 a second set of instructions to modify a first IAM token that is used to access the one or more services associated with the organization 210. Moreover, the second set of instructions may indicate instructions for modifying a set of parameters of the first IAM token to enable access to an identity provider. At 335, the IAM service 205 may receive, from the organization 210 via an application on the 105, a request for information from the identity provider that includes the first IAM token and is based on receiving the second set of instructions. At 340, the IAM service 205 may execute, in response to receiving the request, the second set of instructions to generate a second IAM token to enable access to the identity provider. In some examples, the IAM service 205 may execute the second set of instructions when the request is received or subsequent to receiving the request. Further, the IAM service 205 may query the identity provider using the second IAM token that is generated by executing the second set of instructions to obtain the information associated with the request. Thus, at 345, the IAM service 205 may transmit, to the application on the computing device 105 the information associated with the request based on querying the identity provider.

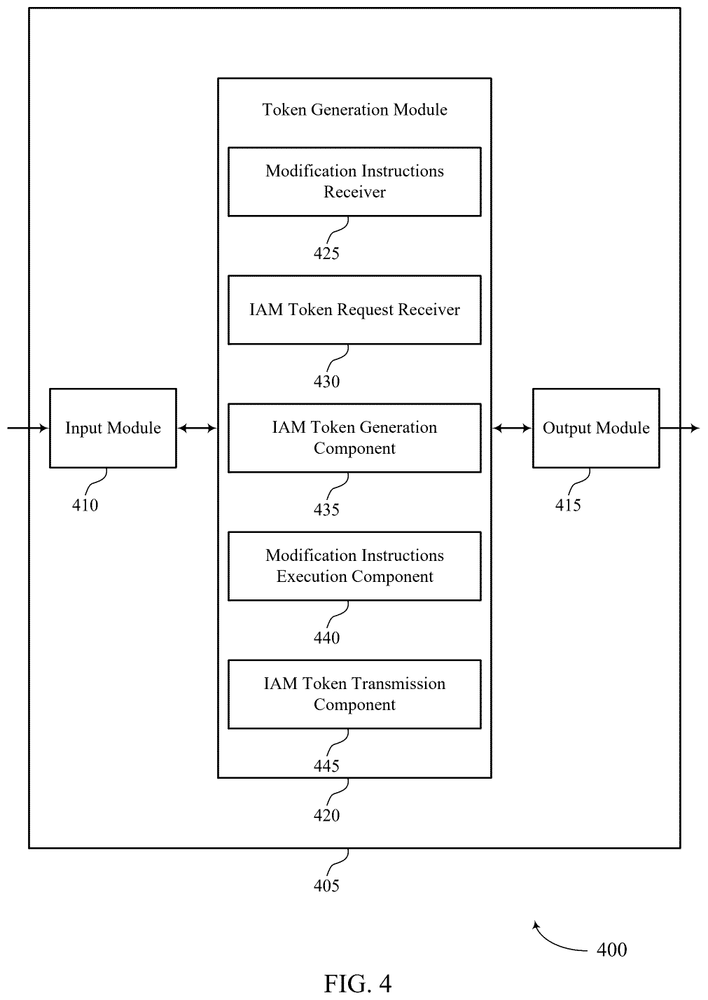

FIG. 4 shows a block diagram 400 of a device 405 that supports customized IAM token generation in accordance with aspects of the present disclosure. The device 405 may include an input module 410, an output module 415, and a token generation module 420. The device 405, or one or more components of the device 405 (e.g., the input module 410, the output module 415, the token generation module 420), may include at least one processor, which may be coupled with at least one memory, to support the described techniques. Each of these components may be in communication with one another (e.g., via one or more buses).

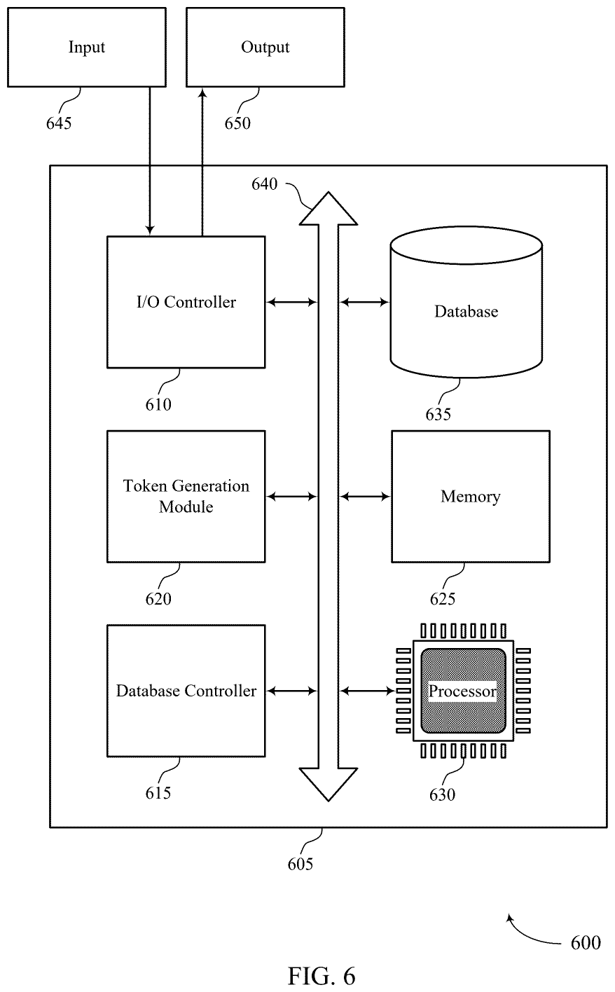

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the token generation module 420 to support customized IAM token generation. In some cases, the input module 410 may be a component of an input/output (I/O) controller 610 as described with reference to FIG. 6.

The output module 415 may manage output signals for the device 405. For example, the output module 415 may receive signals from other components of the device 405, such as the token generation module 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the token generation module 420 may include a modification instructions receiver 425, an IAM token request receiver 430, an IAM token generation component 435, a modification instructions execution component 440, an IAM token transmission component 445, or any combination thereof. In some examples, the token generation module 420, or various components thereof, may be configured to perform various operations (e.g., receiving, monitoring, transmitting) using or otherwise in cooperation with the input module 410, the output module 415, or both. For example, the token generation module 420 may receive information from the input module 410, send information to the output module 415, or be integrated in combination with the input module 410, the output module 415, or both to receive information, transmit information, or perform various other operations as described herein.

The token generation module 420 may support IAM token generation in accordance with examples as disclosed herein. The modification instructions receiver 425 may be configured to support receiving, from an organization, a set of instructions to modify a respective IAM token, where the set of instructions are for modifying a set of parameters of the respective IAM token to enable customized access to one or more services associated with the organization. The IAM token request receiver 430 may be configured to support receiving, from the organization via an application, a request for an IAM token based on receiving the set of instructions. The IAM token generation component 435 may be configured to support generating, in response to the request, the IAM token for the user. The modification instructions execution component 440 may be configured to support executing the set of instructions received from the organization to generate a modified IAM token using the IAM token. The IAM token transmission component 445 may be configured to support transmitting, to the application, the modified IAM token based on executing the set of instructions to obtain the modified IAM token.

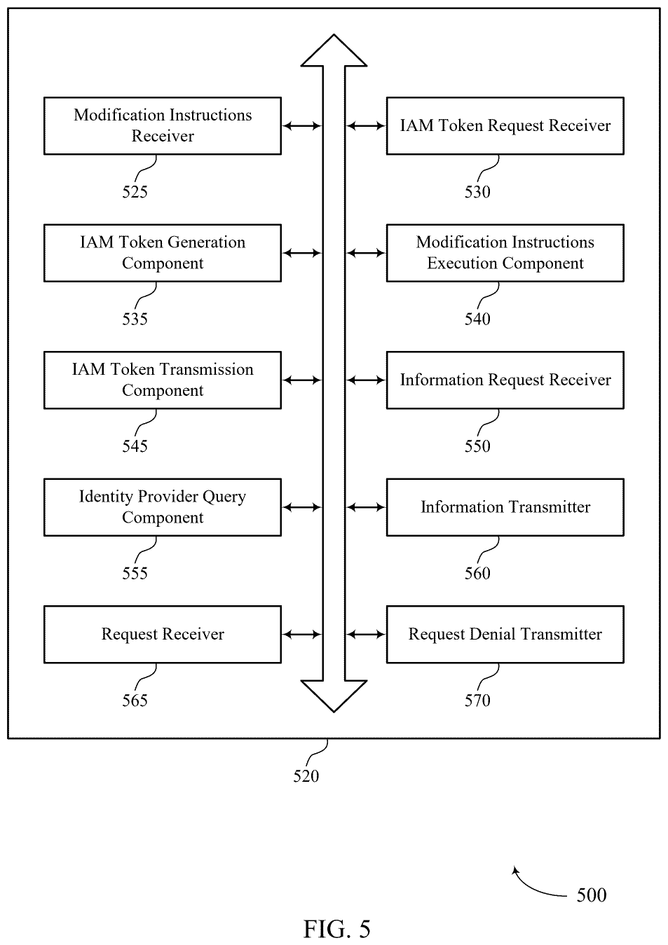

FIG. 5 shows a block diagram 500 of a token generation module 520 that supports customized IAM token generation in accordance with aspects of the present disclosure. The token generation module 520 may be an example of aspects of a token generation module or a token generation module 420, or both, as described herein. The token generation module 520, or various components thereof, may be an example of means for performing various aspects of customized IAM token generation as described herein. For example, the token generation module 520 may include a modification instructions receiver 525, an IAM token request receiver 530, an IAM token generation component 535, a modification instructions execution component 540, an IAM token transmission component 545, an information request receiver 550, an identity provider query component 555, an information transmitter 560, a request receiver 565, a request denial transmitter 570, or any combination thereof. Each of these components, or components of subcomponents thereof (e.g., one or more processors, one or more memories), may communicate, directly or indirectly, with one another (e.g., via one or more buses).

The token generation module 520 may support IAM token generation in accordance with examples as disclosed herein. The modification instructions receiver 525 may be configured to support receiving, from an organization, a set of instructions to modify a respective IAM token, where the set of instructions are for modifying a set of parameters of the respective IAM token to enable customized access to one or more services associated with the organization. The IAM token request receiver 530 may be configured to support receiving, from the organization via an application, a request for an IAM token based on receiving the set of instructions. The IAM token generation component 535 may be configured to support generating, in response to the request, the IAM token for the user. The modification instructions execution component 540 may be configured to support executing the set of instructions received from the organization to generate a modified IAM token using the IAM token. The IAM token transmission component 545 may be configured to support transmitting, to the application, the modified IAM token based on executing the set of instructions to obtain the modified IAM token.

In some examples, the modification instructions receiver 525 may be configured to support receiving, from the organization, a second set of instructions to modify a first IAM token that is used to access the one or more services associated with the organization, where the second set of instructions indicate instructions for modifying a set of parameters of the first IAM token to enable access to an identity provider. In some examples, the information request receiver 550 may be configured to support receiving, from the organization via the application and based on receiving the second set of instructions, a request for information from the identity provider, the request including the first IAM token. In some examples, the modification instructions execution component 540 may be configured to support executing, in response to receiving the request, the second set of instructions to generate a second IAM token to enable customized access to the identity provider. In some examples, the identity provider query component 555 may be configured to support querying the identity provider using the second IAM token generated by executing the second set of instructions to obtain the information associated with the request. In some examples, the information transmitter 560 may be configured to support transmitting, to the application, the information associated with the request based on querying the identity provider.

In some examples, the second set of instructions are executed when the request is received or subsequent to receiving the request.

In some examples, to support executing the set of instructions, the modification instructions execution component 540 may be configured to support including in the modified IAM token that is generated via the set of instructions an indication that the modified IAM token was generated based on executing the set of instructions, including a signature from an identity provider in the modified IAM token, or both.

In some examples, the request receiver 565 may be configured to support receiving, from the application, a request including the modified IAM token that includes the indication. In some examples, the request denial transmitter 570 may be configured to support transmitting, to the application, a denial of the request based on the modified IAM token including the indication.

In some examples, to support executing the set of instructions, the modification instructions execution component 540 may be configured to support modifying one or more parameters of the IAM token to generate the modified IAM token.

In some examples, modifying the one or more parameters of the IAM token includes adding additional parameters, removing parameters, updating a value of one or more respective parameters, or any combination thereof.

In some examples, to support receiving the set of instructions, the modification instructions receiver 525 may be configured to support receiving, from the organization, a unit of executable code, a computer program, or a combination thereof that include the set of instructions.

FIG. 6 shows a diagram of a system 600 including a device 605 that supports customized IAM token generation in accordance with aspects of the present disclosure. The device 605 may be an example of or include components of a device 405 as described herein. The device 605 may include components for bi-directional voice and data communications including components for transmitting and receiving communications, such as a token generation module 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting customized IAM token generation). The processor 630 may be an example of a single processor or multiple processors. For example, the device 605 may include one or more processors 630.

The token generation module 620 may support IAM token generation in accordance with examples as disclosed herein. For example, the token generation module 620 may be configured to support receiving, from an organization, a set of instructions to modify a respective IAM token, where the set of instructions are for modifying a set of parameters of the respective IAM token to enable customized access to one or more services associated with the organization. The token generation module 620 may be configured to support receiving, from the organization via an application, a request for an IAM token based on receiving the set of instructions. The token generation module 620 may be configured to support generating, in response to the request, the IAM token for the user. The token generation module 620 may be configured to support executing the set of instructions received from the organization to generate a modified IAM token using the IAM token. The token generation module 620 may be configured to support transmitting, to the application, the modified IAM token based on executing the set of instructions to obtain the modified IAM token.

By including or configuring the token generation module 620 in accordance with examples as described herein, the device 605 may support techniques for an IAM service to generate an IAM token than enables customized access to services associated with an organization to support reduced latency, reduced user complexity, and an increased security due to tokens being generated solely by the IAM service.

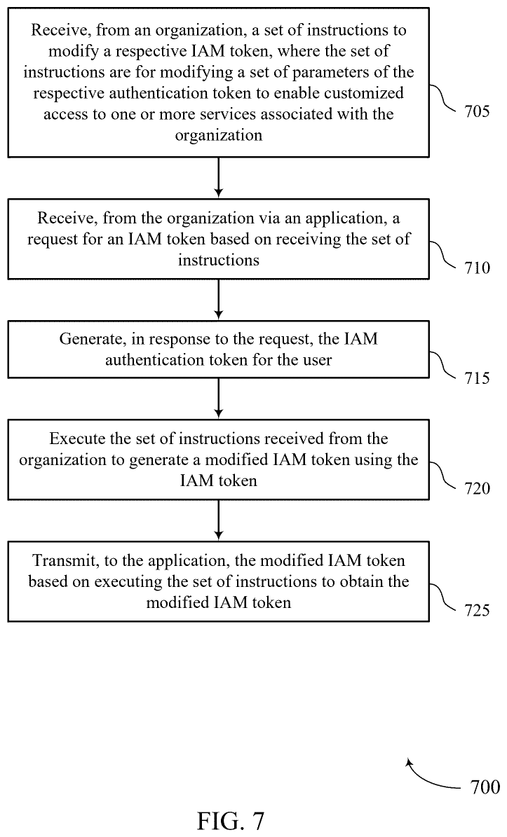

FIG. 7 shows a flowchart illustrating a method 700 that supports customized IAM token generation in accordance with aspects of the present disclosure. The operations of the method 700 may be implemented by an IAM service or its components as described herein. For example, the operations of the method 700 may be performed by an IAM service as described with reference to FIGS. 1 through 6. In some examples, an IAM service may execute a set of instructions to control the functional elements of the IAM service to perform the described functions. Additionally, or alternatively, the IAM service may perform aspects of the described functions using special-purpose hardware.

At 705, the method may include receiving, from an organization, a set of instructions to modify a respective IAM token, where the set of instructions are for modifying a set of parameters of the respective IAM token to enable customized access to one or more services associated with the organization. The operations of 705 may be performed in accordance with examples as disclosed herein. In some examples, aspects of the operations of 705 may be performed by a modification instructions receiver 525 as described with reference to FIG. 5.

At 710, the method may include receiving, from the organization via an application, a request for an IAM token based on receiving the set of instructions. The operations of 710 may be performed in accordance with examples as disclosed herein. In some examples, aspects of the operations of 710 may be performed by an IAM token request receiver 530 as described with reference to FIG. 5.

At 715, the method may include generating, in response to the request, the IAM token for the user. The operations of 715 may be performed in accordance with examples as disclosed herein. In some examples, aspects of the operations of 715 may be performed by an IAM token generation component 535 as described with reference to FIG. 5.

At 720, the method may include executing the set of instructions received from the organization to generate a modified IAM token using the IAM token. The operations of 720 may be performed in accordance with examples as disclosed herein. In some examples, aspects of the operations of 720 may be performed by a modification instructions execution component 540 as described with reference to FIG. 5.

At 725, the method may include transmitting, to the application, the modified IAM token based on executing the set of instructions to obtain the modified IAM token. The operations of 725 may be performed in accordance with examples as disclosed herein. In some examples, aspects of the operations of 725 may be performed by an IAM token transmission component 545 as described with reference to FIG. 5.

The following provides an overview of aspects of the present disclosure:
Aspect 1: A method for IAM token generation, comprising: receiving, from an organization, a set of instructions to modify a respective IAM token, wherein the set of instructions are for modifying a set of parameters of the respective IAM token to enable customized access to one or more services associated with the organization; receiving, from the organization via an application, a request for an IAM token based at least in part on receiving the set of instructions; generating, in response to the request, the IAM token for the user; executing the set of instructions received from the organization to generate a modified IAM token using the IAM token; and transmitting, to the application, the modified IAM token based at least in part on executing the set of instructions to obtain the modified IAM token.
Aspect 2: The method of aspect 1, further comprising: receiving, from the organization, a second set of instructions to modify a first IAM token that is used to access the one or more services associated with the organization, wherein the second set of instructions indicate instructions for modifying a set of parameters of the first IAM token to enable access to an identity provider; receiving, from the organization via the application and based at least in part on receiving the second set of instructions, a request for information from the identity provider, the request comprising the first IAM token; executing, in response to receiving the request, the second set of instructions to generate a second IAM token to enable customized access to the identity provider; querying the identity provider using the second IAM token generated by executing the second set of instructions to obtain the information associated with the request; and transmitting, to the application, the information associated with the request based at least in part on querying the identity provider.
Aspect 3: The method of aspect 2, wherein the second set of instructions are executed when the request is received or subsequent to receiving the request.
Aspect 4: The method of any of aspects 1 through 3, wherein executing the set of instructions comprises: including in the modified IAM token that is generated via the set of instructions an indication that the modified IAM token was generated based at least in part on executing the set of instructions, including a signature from an identity provider in the modified IAM token, or both.
Aspect 5: The method of aspect 4, further comprising: receiving, from the application, a request comprising the modified IAM token that comprises the indication; and transmitting, to the application, a denial of the request based at least in part on the modified IAM token comprising the indication.
Aspect 6: The method of any of aspects 1 through 5, wherein executing the set of instructions comprises: modifying one or more parameters of the IAM token to generate the modified IAM token.
Aspect 7: The method of aspect 6, wherein modifying the one or more parameters of the IAM token comprises adding additional parameters, removing parameters, updating a value of one or more respective parameters, or any combination thereof.
Aspect 8: The method of any of aspects 1 through 7, wherein receiving the set of instructions comprises: receiving, from the organization, a unit of executable code, a computer program, or a combination thereof that include the set of instructions.
Aspect 9: An apparatus for IAM token generation, comprising one or more memories storing processor-executable code, and one or more processors coupled with the one or more memories and individually or collectively operable to execute the code to cause the apparatus to perform a method of any of aspects 1 through 8.
Aspect 10: An apparatus for IAM token generation, comprising at least one means for performing a method of any of aspects 1 through 8.
Aspect 11: A non-transitory computer-readable medium storing code for IAM token generation, the code comprising instructions executable by one or more processors to perform a method of any of aspects 1 through 8.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations, and does not represent all the examples that may be implemented, or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by one or more processors, firmware, or any combination thereof. If implemented in software executed by one or more processors, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for identity and access management (IAM) token generation, comprising:
receiving, from an organization, a set of instructions to modify a respective IAM token, wherein the set of instructions are for modifying a set of parameters of the respective IAM token to enable customized access to one or more services associated with the organization;
receiving, from the organization via an application, a request for an IAM token based at least in part on receiving the set of instructions;
generating, in response to the request, the IAM token for the application;
executing the set of instructions received from the organization to generate a modified IAM token using the IAM token; and
transmitting, to the application, the modified IAM token based at least in part on executing the set of instructions to obtain the modified IAM token.

2. The method of claim 1, further comprising:
receiving, from the organization, a second set of instructions to modify a first IAM token that is used to access the one or more services associated with the organization, wherein the second set of instructions indicate instructions for modifying a set of parameters of the first IAM token to enable access to an identity provider;
receiving, from the organization via the application and based at least in part on receiving the second set of instructions, a request for information from the identity provider, the request comprising the first IAM token;
executing, in response to receiving the request, the second set of instructions to generate a second IAM token to enable access to the identity provider;
querying the identity provider using the second IAM token generated by executing the second set of instructions to obtain the information associated with the request; and
transmitting, to the application, the information associated with the request based at least in part on querying the identity provider.

3. The method of claim 2, wherein the second set of instructions are executed when the request is received or subsequent to receiving the request.

4. The method of claim 1, wherein executing the set of instructions comprises:
including in the modified IAM token that is generated via the set of instructions an indication that the modified IAM token was generated based at least in part on executing the set of instructions, including a signature from an identity provider in the modified IAM token, or both.

5. The method of claim 4, further comprising:
receiving, from the application, a request comprising the modified IAM token that comprises the indication; and
transmitting, to the application, a denial of the request based at least in part on the modified IAM token comprising the indication.

6. The method of claim 1, wherein executing the set of instructions comprises:
modifying one or more parameters of the IAM token to generate the modified IAM token.

7. The method of claim 6, wherein modifying the one or more parameters of the IAM token comprises adding additional parameters, removing parameters, updating a value of one or more respective parameters, or any combination thereof.

8. The method of claim 1, wherein receiving the set of instructions comprises:
receiving, from the organization, a unit of executable code, a computer program, or a combination thereof that include the set of instructions.

9. An apparatus for identity and access management (IAM) token generation, comprising:
one or more memories storing processor-executable code; and
one or more processors coupled with the one or more memories and individually or collectively operable to execute the code to cause the apparatus to:
receive, from an organization, a set of instructions to modify a respective IAM token, wherein the set of instructions are for modifying a set of parameters of the respective IAM token to enable customized access to one or more services associated with the organization;
receive, from the organization via an application, a request for an IAM token based at least in part on receiving the set of instructions;
generate, in response to the request, the IAM token for the application;
execute the set of instructions received from the organization to generate a modified IAM token using the IAM token; and
transmit, to the application, the modified IAM token based at least in part on executing the set of instructions to obtain the modified IAM token.

10. The apparatus of claim 9, wherein the one or more processors are individually or collectively further operable to execute the code to cause the apparatus to:
receive, from the organization, a second set of instructions to modify a first IAM token that is used to access the one or more services associated with the organization, wherein the second set of instructions indicate instructions for modifying a set of parameters of the first IAM token to enable access to an identity provider;
receive, from the organization via the application and based at least in part on receiving the second set of instructions, a request for information from the identity provider, the request comprising the first IAM token;
execute, in response to receiving the request, the second set of instructions to generate a second IAM token to enable access to the identity provider;
query the identity provider using the second IAM token generated by executing the second set of instructions to obtain the information associated with the request; and
transmit, to the application, the information associated with the request based at least in part on querying the identity provider.

11. The apparatus of claim 9, wherein, to execute the set of instructions, the one or more processors are individually or collectively operable to execute the code to cause the apparatus to:
include in the modified IAM token that is generated via the set of instructions an indication that the modified IAM token was generated based at least in part on executing the set of instructions, including a signature from an identity provider in the modified IAM token, or both.

12. The apparatus of claim 11, wherein the one or more processors are individually or collectively further operable to execute the code to cause the apparatus to:
receive, from the application, a request comprising the modified IAM token that comprises the indication; and
transmit, to the application, a denial of the request based at least in part on the modified IAM token comprising the indication.

13. The apparatus of claim 9, wherein, to execute the set of instructions, the one or more processors are individually or collectively operable to execute the code to cause the apparatus to:
modify one or more parameters of the IAM token to generate the modified IAM token.

14. The apparatus of claim 13, wherein modifying the one or more parameters of the IAM token comprises adding additional parameters, removing parameters, updating a value of one or more respective parameters, or any combination thereof.

15. A non-transitory computer-readable medium storing code for identity and access management (IAM) token generation, the code comprising instructions executable by one or more processors to:
receive, from an organization, a set of instructions to modify a respective IAM token, wherein the set of instructions are for modifying a set of parameters of the respective IAM token to enable customized access to one or more services associated with the organization;
receive, from the organization via an application, a request for an IAM token based at least in part on receiving the set of instructions;
generate, in response to the request, the IAM token for the application;
execute the set of instructions received from the organization to generate a modified IAM token using the IAM token; and
transmit, to the application, the modified IAM token based at least in part on executing the set of instructions to obtain the modified IAM token.

16. The non-transitory computer-readable medium of claim 15, wherein the instructions are further executable by the one or more processors to:
receive, from the organization, a second set of instructions to modify a first IAM token that is used to access the one or more services associated with the organization, wherein the second set of instructions indicate instructions for modifying a set of parameters of the first IAM token to enable access to an identity provider;
receive, from the organization via the application and based at least in part on receiving the second set of instructions, a request for information from the identity provider, the request comprising the first IAM token;
execute, in response to receiving the request, the second set of instructions to generate a second IAM token to enable access to the identity provider;
query the identity provider using the second IAM token generated by executing the second set of instructions to obtain the information associated with the request; and
transmit, to the application, the information associated with the request based at least in part on querying the identity provider.

17. The non-transitory computer-readable medium of claim 15, wherein the instructions to execute the set of instructions are executable by the one or more processors to:
include in the modified IAM token that is generated via the set of instructions an indication that the modified IAM token was generated based at least in part on executing the set of instructions, including a signature from an identity provider in the modified IAM token, or both.

18. The non-transitory computer-readable medium of claim 17, wherein the instructions are further executable by the one or more processors to:
receive, from the application, a request comprising the modified IAM token that comprises the indication; and
transmit, to the application, a denial of the request based at least in part on the modified IAM token comprising the indication.

19. The non-transitory computer-readable medium of claim 15, wherein the instructions to execute the set of instructions are executable by the one or more processors to:
modify one or more parameters of the IAM token to generate the modified IAM token.

20. The non-transitory computer-readable medium of claim 19, wherein modifying the one or more parameters of the IAM token comprises adding additional parameters, removing parameters, updating a value of one or more respective parameters, or any combination thereof.
